(19) United States
(12) Patent Application Publication
(10) Pub. No.: US 2009/0249034 A1
(43) Pub. Date: Oct. 1, 2009

(54) PROCESSOR AND SIGNATURE GENERATION METHOD, AND MULTIPLE SYSTEM AND MULTIPLE EXECUTION VERIFICATION METHOD

(75) Inventor: Mitsuru SATO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/390,894

(22) Filed: Feb. 23, 2009

(30) Foreign Application Priority Data
Mar. 28, 2008 (JP) 2008-85272

(51) Int. Cl. G06F 9/30

(52) U.S. Cl. 712/214; 712/E09.016

(57) ABSTRACT

A processor performs instruction execution regardless of a program order. An execution unit executes an instruction, and transmits end information of the instruction whose execution has ended. A retire unit receives the end information, rearranges a result of the instruction whose execution has ended in a program order to determine the instruction execution, and transmits completed instruction information which reports that the instruction execution has been determined. A signature generation unit receives the completed instruction information from the retire unit, and generates a signature using the completed instruction information.

### CROSS-REFERENCE TO RELATED APPLICATIONS

This application is related to and claims priority to Japanese patent application No. 2008-85272 filed on Mar. 28, 2008 in the Japan Patent Office, and incorporated by reference herein.

### BACKGROUND

1. Field

The embodiments discussed herein are directed to a technology which facilitates multiple execution verification adopted in a computer system of which high reliability is required.

2. Description of the Related Art

In recent years, a computer system has become widely prevalent in society, and indispensable as a social infrastructure. With this trend, the reliability of the computer system has become increasingly important. On the other hand, there has conventionally been a strong demand for improvements in the performance of the computer system so that the computer system has been required to have both improved performance and reliability.

Every year, an LSI (large Scale Integration) constituting the computer system has been increasingly miniaturized and reduced in voltage to have an improved operation frequency, and respond to the demand for the improved performance. On the other hand, the miniaturization and voltage reduction thereof increase susceptibility to disturbance, and the reliability of an individual single LSI has tended to be lowered. For example, it is known that the frequency of a phenomenon called a soft error, which is the inversion of data held within an LSI due to cosmic radiation, increases as the LSI is more highly integrated. This has presented a serious problem even at the present time.

In order to compensate for lowered reliability of an individual LSI, a structural scheme for improving reliability has been used in a system of which reliability is required. For instance, in the example of the soft error mentioned above, an error correction code which allows, even when a 1-bit inversion occurs in the content of a memory, the inverted one bit to be restored to an original state is used in a large number of calculators.

The error correction code is the scheme for improving reliability which is limited to the memory. A method widely used as a scheme for directly improving the reliability of the result of execution by a calculator is a multiple execution method.

The multiple execution method is a method which executes the same program a plurality of number of times, verifies whether or not the execution results match, and guarantees the validity of the results by adopting the result matching with a plurality of the results (see FIG. 11). When the same data is given as an input, unless a problem such as a failure or the like occurs during calculation, the calculation result should be the same. Therefore, by recognizing a match among the plurality of calculation results, it is possible to reduce the probability of the occurrence of a problem such as a failure or the like during calculation.

When a difference is found as a result of comparing the plurality of execution results, and when there are three or more execution results, the result considered to be proper can be selected using a majority vote. When there are two execution results, such a method which performs the execution again or issues a warning to a user is used. Further, Japanese Laid-open Patent Publication No. H11-085713 a structure capable of high level processing such that, when execution is simultaneously performed in a plurality of calculation units, the execution unit which has outputted a result different from the other execution results is disconnected from a system on the assumption that a failure has occurred therein.

Thus, in the computer system, the multiple execution method has been used in order to improve reliability. In the multiple execution method, how to perform match verification of the execution results is an extremely important point.

In the multiple execution method, it is only after the procedure of “program execution” and subsequent “match verification of execution results” that the program execution is determined to be reliable. As a result, as the time required to perform the match verification of the execution results is longer, the time required until the program execution is determined is accordingly longer, which results in the degraded performance of the computer system. Therefore, it is necessary to perform the match verification of the execution results at a high speed.

In performing the verification at a high speed, selection of the “execution results” and a unit for verification which are used for the verification are important. A matter of what is used as the execution result is comparable to a matter of at which level multiplication is to be performed.

On the other hand, the unit for verification is synonymous with what type of a comparison method is to be used.

Thus far, a “signature check” has been proposed as the multiple execution method.

A signature is a code generated by extracting a characteristic portion from a set of information. Since the execution results outputted from a microprocessor are huge in quantity, it is difficult to make a complete comparison among the execution results without alteration. To eliminate the difficulty, there is a “signature check” method which generates signatures from output data, and makes only a comparison among the signatures as a substitute for a comparison of entire output data.

The signature generation methods include various methods. For example, the signatures can be generated by such methods which use a check sum, a CRC (Cyclic Redundancy Check), a LFSR (Linear Feedback Shift Register), or the like.

The “signature check” method is inferior in detection ability relative to a method which makes a complete comparison among outputted results, but requires only an extremely short time for a match inspection. By considering the extremely low frequency of the occurrence of a failure, and using a proper method as the signature generation method, it is possible to inspect a match among the outputted results with sufficiently high accuracy. In the “signature check” method, how to generate a signature presents a problem. A method of generating a signature using software requires a longer time for signature generation than an inspection for a match among the outputted results, and therefore loses the advantage of the signature check. A multiple high-reliability system according to the conventional “signature check” method has the following problems.

In Japanese Laid-open Patent Publication No. H06-83663, a signature is generated from the internal state of a microprocessor, and a multiple high-reliability system using the signature is constructed.

In the system discussed in Japanese Laid-open Patent Publication No. H06-83663, the signature is generated from the state of the microprocessor such as, e.g., the state of a pipeline, an instruction during execution, data outputted through execution or the like. However, the internal structure of a contemporary microprocessor is complicated such that, even when execution results are the same, the internal states of the microprocessors may differ in quite a few cases. For example, in out-of-order execution used in the contemporary high-speed microprocessor, the microprocessor can freely change the order of instructions to a degree. Accordingly, even when the same program is executed, the order of instruction execution in one processor may be different from that in another processor. A recent microprocessor also has a large amount of an embedded cache, but the operation of the microprocessor also differs depending on the amount of the cache. In particular, in a microprocessor equipped with the function of disconnecting only the failed part while continuing execution, when a part of the cache physically fails, even processors having the same cache size may internally behave differently. Therefore, the signature generation method using the internal state of a microprocessor can not be applied to a computer system constituted by a contemporary microprocessor.

Japanese Laid-open Patent Publication No. 2002-312190 also similarly discusses a technology related to a microprocessor using a signature. In the system disclosed in Japanese Laid-open Patent Publication No. 2002-312190, the signature is generated from information written in a register file. The information written in the register file is transmitted to a signature generator, and simultaneously stored in a register structured in a stacked configuration. The system adopts a method such that, when a given period of time has elapsed, signatures of two or more processors are compared with each other and, when the signatures match, a 1-stage advancement is made in the register having the stacked configuration, and the information written in the register file is actually reflected. With this method, the high-reliability system is constructed.

The system disclosed in Japanese Laid-open Patent Publication No. 2002-312190 uses the register file having the stacked configuration. This ensures that the information written in the register file is reflected after an inspection for a signature match, and allows high-reliability execution. However, the register file having the stacked configuration requires a large amount of memory, and further causes the microprocessor to require various additional circuit(s), such as an inspection circuit for a signature match or a rerun circuit used in the event of a mismatch. As a result, it becomes necessary to significantly change an existing microprocessor, which requires high cost.

In Japanese Laid-open Patent Publication No. 2002-312190, an application to an out-of-order processor is also mentioned. However, since it is necessary to match signatures cumulatively generated from a sequence of instructions whose positions in execution order have been changed, a method which does not depend on the order (such as, e.g., the check sum) should be used as the signature generation method. This is a method inferior in detection ability to a method which depends on the order (such as, e.g., the CRC, the LFSR, or the like), and leads to the problem of a reduction in failure detecting ability.

In view of the foregoing, an object of the present invention is to solve problems including those existing in a multiple high-reliability system according to a multiple execution method using a signature check.

In other words, an object of the present invention includes providing a technique which allows easy and relatively-low-cost implementation of signature generation in a multiple system using an out-of-order processor as a contemporary high-speed processor.

By verifying reliability using a signature generated, the present invention also provides a high-performance and high-reliability multiple system.

### SUMMARY

A processor performs instruction execution regardless of a program order. An execution unit executes an instruction, and transmits end information of the instruction whose execution has ended. An retire unit receives the end information transmitted by the execution unit, rearranges a result of the instruction whose execution has ended in the program order to determine the instruction execution, and transmits completed instruction information which reports that the instruction execution has been determined. The signature generation unit receives the completed instruction information from the retire unit, and generates a signature using the completed instruction information.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a view showing an overall structure of a multiple system;

FIG. 2 is a view showing a structure of a processor;

FIG. 3 is a view showing a structure of (a part on a processor according to an embodiment;

FIG. 4 is a view showing a flow of a process in a multiple system constituted by a processor according to an embodiment;

FIG. 5 is a view showing a structure of an embodiment (A);

FIG. 6 is a view showing a structure of an embodiment (B);

FIG. 7 is a view showing a flow of a process when an embodiment is applied to a multiple high-reliability system which performs multiple executions on a per virtual machine or a process basis;

FIG. 8 is a view showing a structure of (a part off a processor according to an embodiment;

FIG. 9 is a view showing a structure of an embodiment;

FIG. 10 is a view showing a flow of a process in an embodiment; and

FIG. 11 is a view showing a conventional multiple execution method.

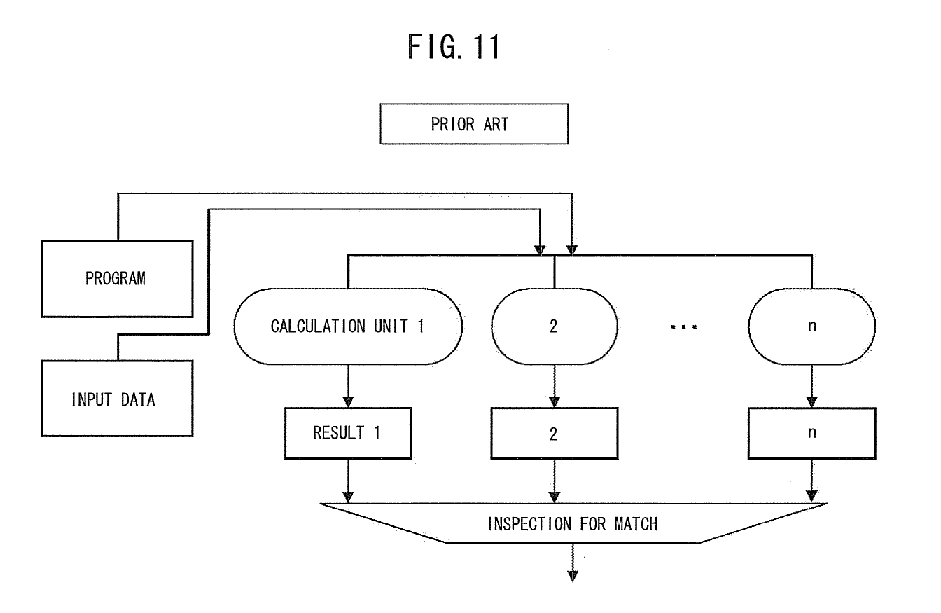

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

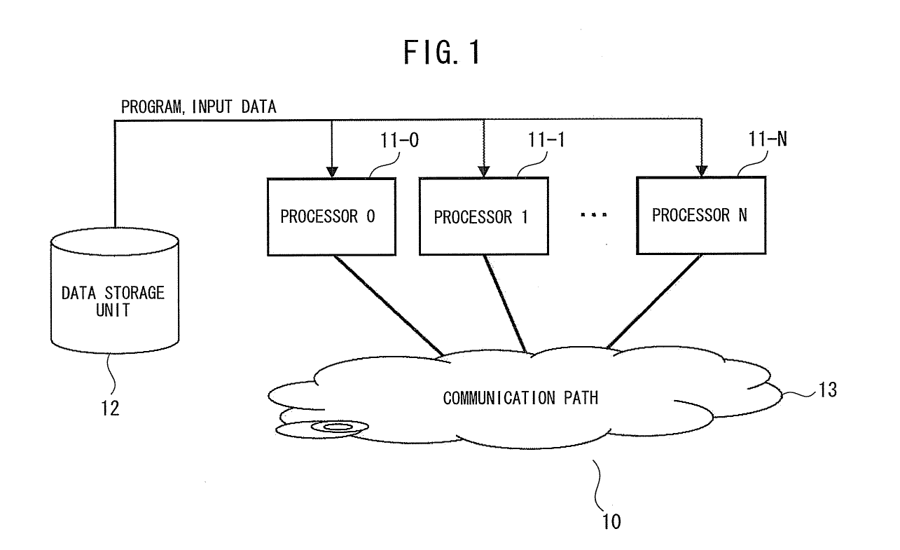

FIG. 1 shows an overall structure of a multiple system according to an embodiment. A description will be given hereinbelow to embodiments, and a structure of FIG. 1 is common to each of the embodiments. The embodiments describe a system structure in which a plurality of processors operate in parallel as a structure of the multiple system. However, the multiple system is not limited thereto. The multiple system may also have a structure in which the same process is repeated n times in one processor.

A multiple system 10 in FIG. 1 includes a plurality of processors 0 (11-0) to N (11-N). A program, user data, and the like are inputted to each of the processors 11 from a data storage unit 12 so that a process such as an instruction execution is performed. A signature is generated in each of the processors 11. At a time when an equal amount of processing ends in each of the processors, e.g., at the time when the execution of a given number of instructions ends in each of the processors, any processor among the plurality of processors, the processor 0 (11-0) for example, collects the signature(s) of the other processors 1 (11-1) to N (11-N) via a communication path 13, and performs a match verification. When there is a mismatching signature as a result of the match verification, an error process such as halting the operation of the processor which has generated the mismatching signature or issuing a warning to a user is performed.

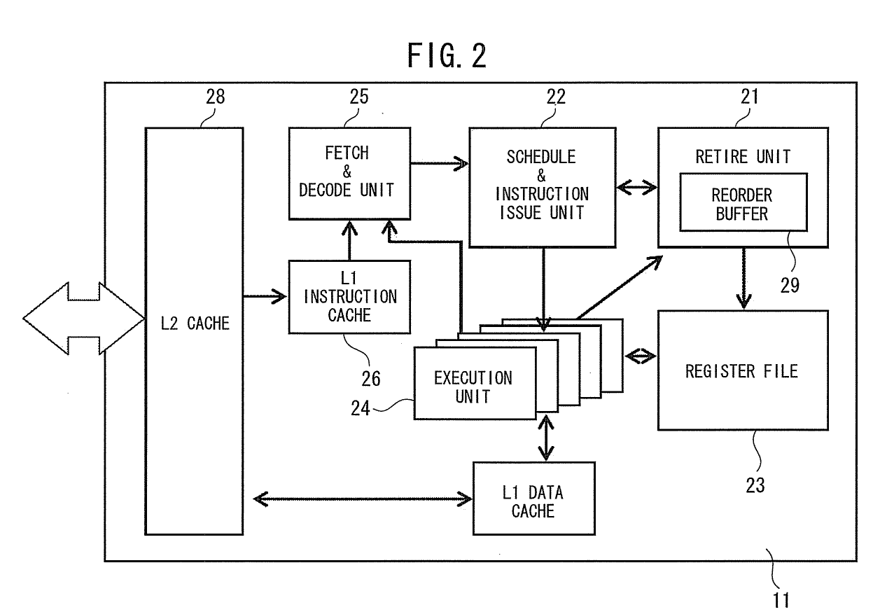

FIG. 2 shows a detailed structure of each of the processor(s) in the embodiment shown in FIG. 1. This is a structure of an out-of-order processor.

The program is fetched by a fetch & decode unit 25 via an L2 cache 28 and an L1 instruction cache 26, and analyzed. The analysis result is sent to a schedule & instruction issue unit 22, where scheduling which does not conform to a program execution order is performed, and the program is executed in an execution unit 24.

In a reorder buffer 29 provided in a retire unit 21, a program order before being split apart in the schedule & instruction issue unit 22 is stored. When the execution in the execution unit 24 is completed, instruction completion information is sent to the retire unit 21. The retire unit 21 rearranges completed result(s) into an original program order based on information in the reorder buffer 29, and sequentially determines execution.

Accordingly, regardless of the order in which the instruction(s) are executed within the processor, the execution result(s) are determined in the program order in the reorder buffer 29 as a result of the rearrangement by the retire unit 21. Conversely, execution end information can be obtained in the program order regardless of an internal instruction execution order as long as information is obtained from the retire unit 21.

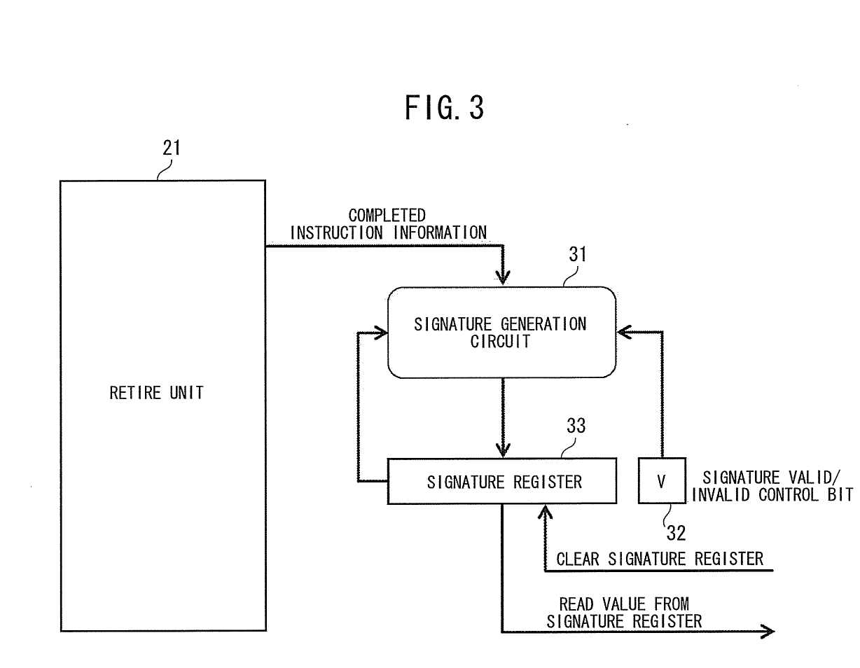

Therefore, in an embodiment, the processor obtains completed instruction information as program-order execution end information from the retire unit 21 within the out-of-order execution processor, as shown in FIG. 3. The completed instruction information is normally called Retire instruction information. Then, a circuit for generating a signature based on the completed instruction information and the like are added to the processor 11.

In FIG. 3, a signature generation circuit 31 generates a signature using a coding unit, for example, such as a check sum, a CRC, or a LFSR. The generated signature is stored in a signature register 33, and provided for next signature generation or data reading from the program.

A signature valid/invalid control bit 32 is a control bit composed of one bit which is set from the program. The value of the signature register 33 is updated only when this bit is in a valid state. When this bit is invalid, the value of the signature register 33 is not updated even when instruction execution is completed.

The signature generation circuit 31 receives the completed instruction information as information on an instruction whose instruction execution has been determined from the retire unit 21. The following are examples of content of the completed instruction information:

Instruction Type

Register Number to be Used (Read, Write)

Data to be Written to Register

Address and Data to be Read from or Written to Memory

Instruction Pointer (IP: Instruction Pointer)

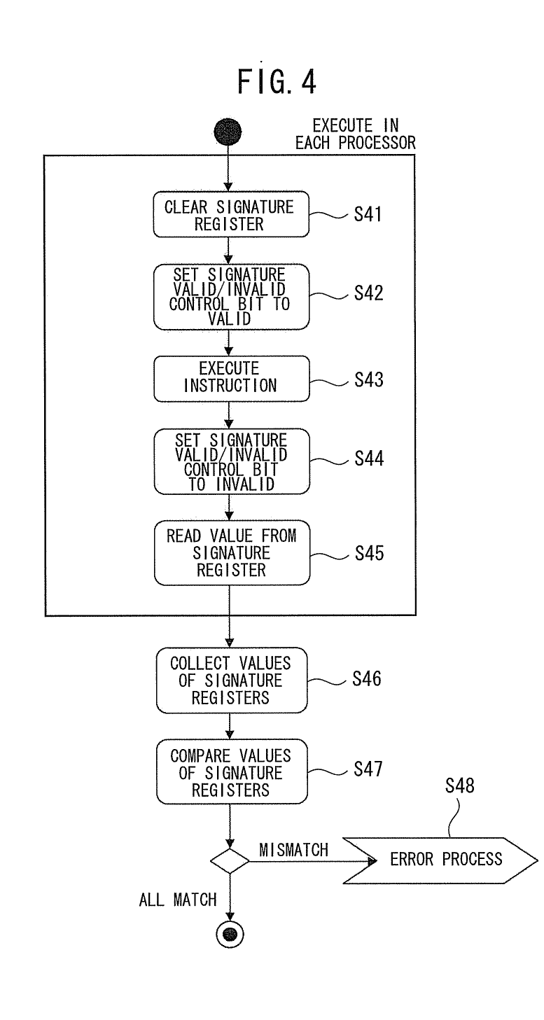

In a multiple system constituted by the processor including the signature register 33 shown in FIG. 3, a process is performed as shown in FIG. 4. The process shown in FIG. 4 is executed by the execution unit 24 using software.

In FIG. 4, the process from S41 to S45 is executed in each of the processors in the multiple system shown in FIG. 1.

The processor clears a signature, for example in the signature register 33, at operation (S41). Then, the processor sets the signature valid/invalid control bit, for example in the signature valid/invalid control bit 32 to “Valid” at operation (S42). The processor executes an instruction (S43). Then, a signature is generated by, for example, the signature generation circuit 31, and the generated signature is stored in the signature register 33.

The program executed in each of the processors generates an interruption at the time when an equal amount of processing ends to cause a task switch. When the task switch is generated, the signature valid/invalid control bit in for example, the signature valid/invalid control bit 32 is set to “Invalid” at operation (S44). Then the processor reads a value, for example, from the signature register 33 at operation (S45).

The value(s) read from the signature registers 33 are collected by the execution unit 24 of any of the processors 11 via the communication path 13 shown in FIG. 1 at operation (S46).

Then, the collected values of the signature registers 33 are compared. When all the collected values match, the current process advances to the next process on the assumption that the instruction execution processed in each of the processors is reliable at operation (S47). When any of the signatures are mismatch, an error process is performed at operation (S48). In the error process, a process such as halting the operation of the processor that has outputted the mismatching value, or issuing a warning to a user is performed.

Thus, the verification process in the multiple system is implemented by generating the interruption at a time when an equal amount of processing ends, and performing the process of making a comparison among a plurality of values of the signature registers 33. A detailed description is given below with respect to “at a time when an equal amount of processing ends”.

Even when the plurality of processors individually operate in the system as shown in FIG. 1, the processes in the respective processors cannot be stopped at completely the same timing because a clock increases in speed, the processors are complicated, and cannot retain the identity of operations therein. In addition, a multiple system in which the same process is repeated n times in one processor may also be considered, and the results of the repeated process are compared thereamong instead of the multiple system in which the same process is performed in each of different processors in parallel as shown in FIG. 1. As a result, a criterion for a “given amount” other than a temporal timing becomes necessary.

As the criterion for the “given amount”, a method which splits apart the process on an application side can be considered. However, since this requires modification of the application, there is another method which uses a given number of instruction executions as the criterion. Since contemporary processors include one which can generate the interruption when a specified number of instructions are executed, thereby the present embodiment uses this function to generate the interruption at the time when a given number of instructions (such as 10,000 instructions) are executed, and makes a comparison among the values of the respective signature registers at that time. That is, the interruption is generated when the processors execute a given number of instructions in S43 of FIG. 4, processing in S44 and S45 is performed in each of the processors, the values of the signature registers 33 in the system are collected by one of the plurality of processors (S46), and the values of the signature registers 33 are compared with each other, so that verification in the system is performed.

Thus far, the description has thus been given to the structure of an embodiment. Hereinbelow, by dividing an embodiment into (A) and (B) using a detailed content of the completed instruction information received from the retire unit 21 which is used when the signature generation circuit 31 generates the signature, a distinctive description will be given thereto.

First, the completed instruction information in the embodiment (A) is composed of an instruction pointer (IP), an instruction type, a register number to be used, data to be written to the register, a memory address to be used, and data to be written to the memory.

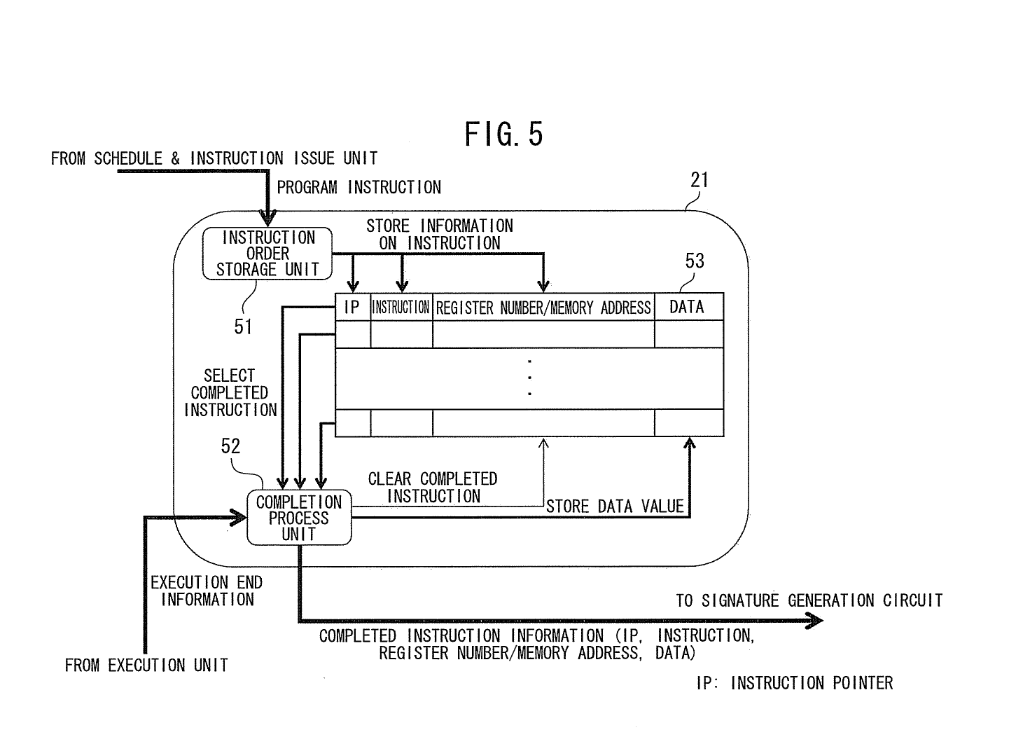

FIG. 5 shows the structure of the retire unit 21 in the embodiment (A).

The retire unit 21 includes an instruction order storage unit 51, a completion process unit 52, and a reorder buffer 53. Information on a program instruction is sent to the instruction order storage unit 51 from the schedule & instruction issue unit 22. Then, the IP, the instruction type, and the resister number/memory address are stored in the reorder buffer 53 as the information on the program instruction.

Information on the instruction whose execution has ended is sent to the completion process unit 52 from the execution unit 24. Then, the completion process unit 52 selectively reads corresponding information from the reorder buffer 53 based on the information on the instruction whose execution has ended, and outputs the read data as the completed instruction information to the signature generation circuit 31. As described above, the completed instruction information has the instruction pointer (IP), the instruction type, the register number to be used, the data to be written to the register, the memory address to be used, and the data to be written to the memory. In the signature generation circuit 31, a signature is generated based on the completed instruction information.

Thus, the completed instruction information in the embodiment (A) uses the information stored in the reorder buffer 53 as the completed instruction information without alteration, but the completed instruction information includes information showing an internal state which does not influence the program execution. In view of this, the embodiment (B) adopts a structure in which it is considered that the operations in the processors match irrespective of the internal states of the processors as long as there is a match only among information items to be written to the memory, which are outputs to the outside, and only the information items to be written to the memory are used as inputs to the signature generation circuit.

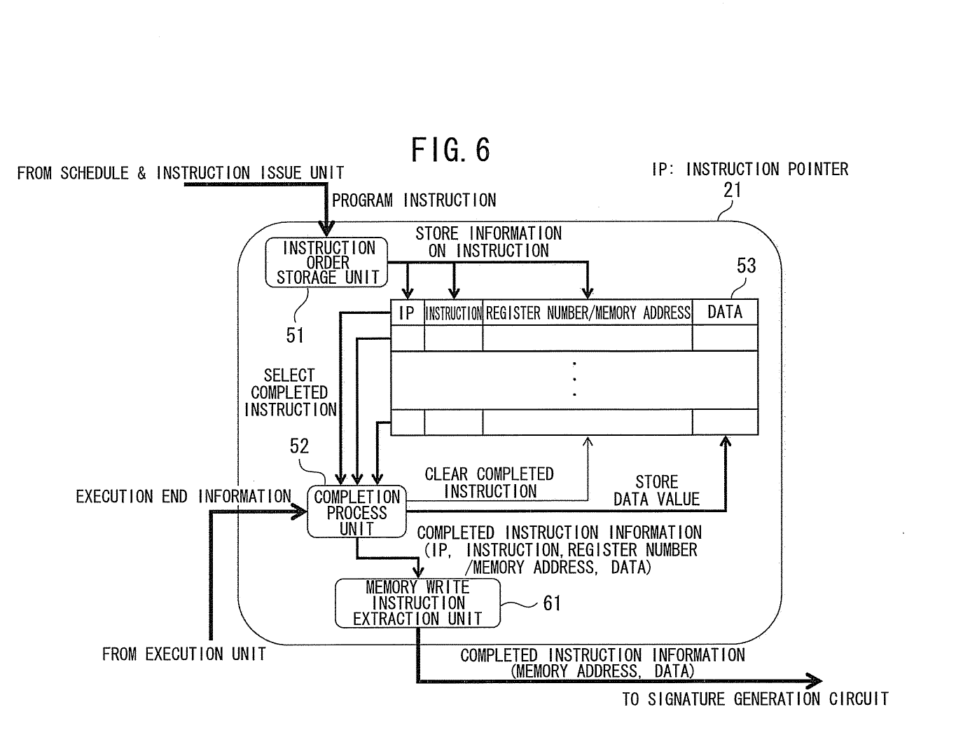

FIG. 6 shows the structure of the retire unit 21 in the embodiment (B).

In the same manner as in the embodiment (A), the retire unit 21 includes the instruction order storage unit 51, the completion process unit 52, and the reorder buffer 53. Information on the program instruction is sent to the instruction order storage unit 51 from the schedule & instruction issue unit 22. Then, the IP, the instruction type, and the resister number/memory address are stored in the reorder buffer 53 as the information on the program instruction from the instruction order storage unit 51.

Information on the instruction whose execution has ended is sent to the completion process unit 52 from the execution unit 24. Then, the completion process unit 52 selectively reads, as the completed instruction information, corresponding information from the reorder buffer 53 based on the information of the instruction whose execution has ended.

In the embodiment (B), the completed instruction information that has been read is inputted to a memory write instruction extraction unit 61. Then, the memory write instruction extraction unit 61 extracts only an instruction to perform writing to the memory, and further outputs, as the completed instruction information, information composed of the memory address to which writing is to be performed, and data to be written to the memory to the signature generation circuit 31. The signature generation circuit 31 generates a signature based on the completed instruction information that has been outputted.

By limiting an input to the signature generation circuit 31 as in the embodiment (B), the structure of the signature generation circuit can be simplified, and prevent a mismatch among internal states which does not influence the program execution from being detected as a system failure.

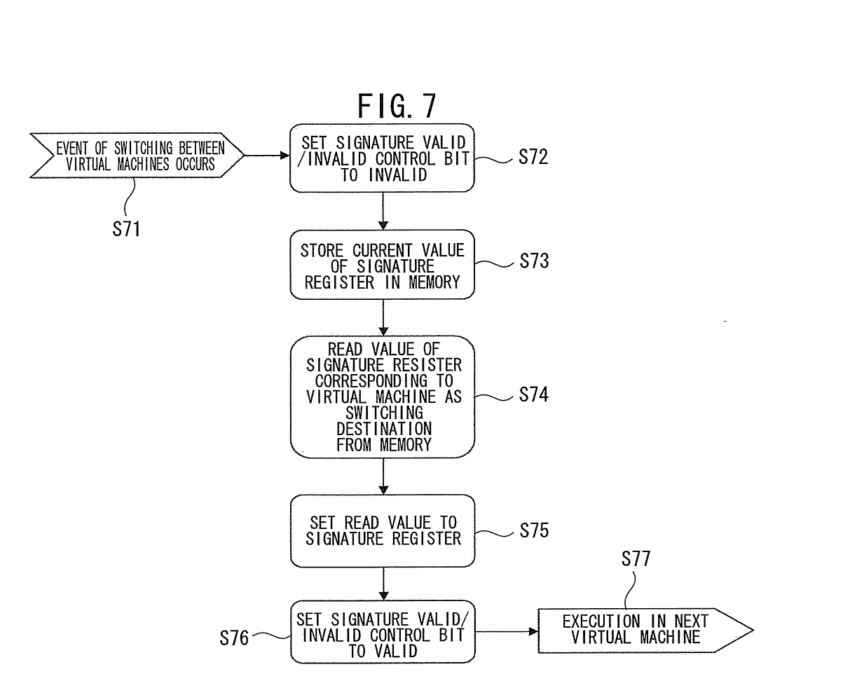

When an embodiment is implemented with a multiple high-reliability system which performs multiple execution on a per virtual machine or process basis, a process as shown in FIG. 7 is performed in the instruction execution process of operation S43 shown in FIG. 4.

First, when an event of switching between virtual machines or processes occurs at operation (S71), the processor sets the signature valid/invalid control bit for example via the processor sets the signature valid/invalid control bit 32 to “Invalid” at operation (S72). Then, the processor stores the current value of the signature register 33 in the memory or the like at operation (S73).

The processor reads the value of the signature register 33 corresponding to the virtual machine or process as the switching destination from the memory or the like at operation (S74). The processor sets the read value to the signature register, for example in the signature register 33 at operation (S75). The processor sets the signature valid/invalid control bit to “Valid” at operation (S76). Then, a processing in the next virtual machine or process is executed at operation (S77).

Thus, every time execution in the virtual machine or process switches, a process of saving the content of the signature register, reading the value of the signature register corresponding to the virtual machine in which execution is subsequently performed from the memory or the like, and resets the value are performed. The occurrence of such a process on each switching of the virtual machine or process may prevent higher-speed processing in the entire system. As a method for solving such a problem, a structure of an embodiment is shown next.

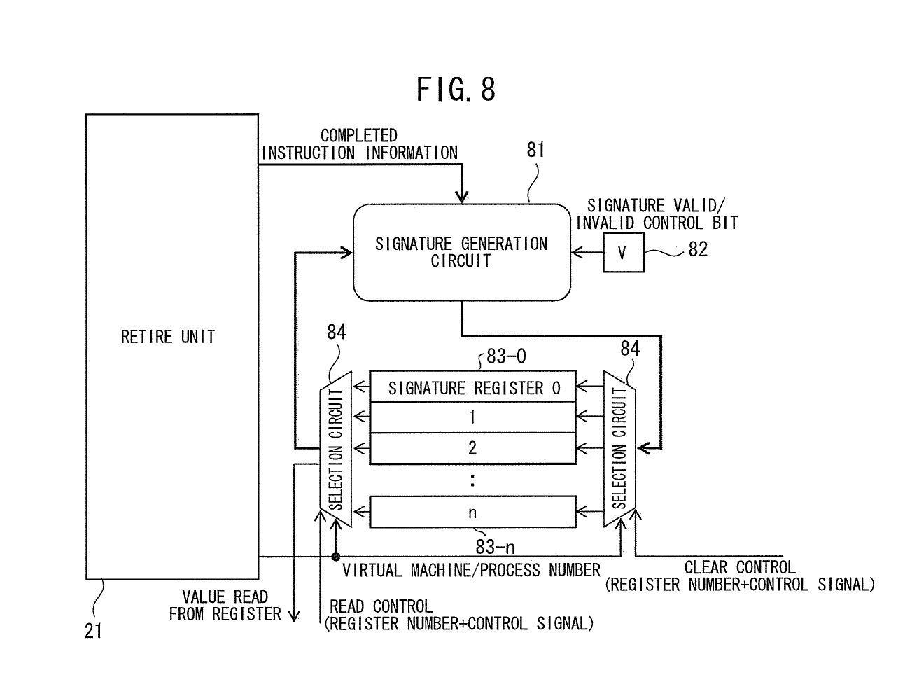

FIG. 8 shows a structure of a processor according to an embodiment. In the same manner as in FIG. 3 of an embodiment, the processor obtains the completed instruction information as program-order execution end information from the retire unit 21 within the out-of-order execution processor. Based on the completed instruction information, the processor adds a circuit for generating a signature and the like to the processor 11 of FIG. 2. This embodiment is the same as the above-described embodiment in that a signature generation circuit 81, and a signature valid/invalid control bit 82 are provided.

In an embodiment, a plurality of signature registers 83 are prepared. It is assumed that each of the signature registers (83-0 to 83-n) can hold the signature generated by the signature generation circuit 81, and read/write data from the program.

In addition, a selection circuit 84 which selects among the signature registers 83 is provided to allow the selection of which one of the plurality of signature registers 83 is to be used. For data serving as a selection key, a virtual machine ID or a process ID to which an instruction whose execution has been determined obtained from the retire unit 21 belongs is used. As such, selection from among the plurality of signature registers may be implemented as requested and/or automatically based on a selection key such as a virtual machine ID.

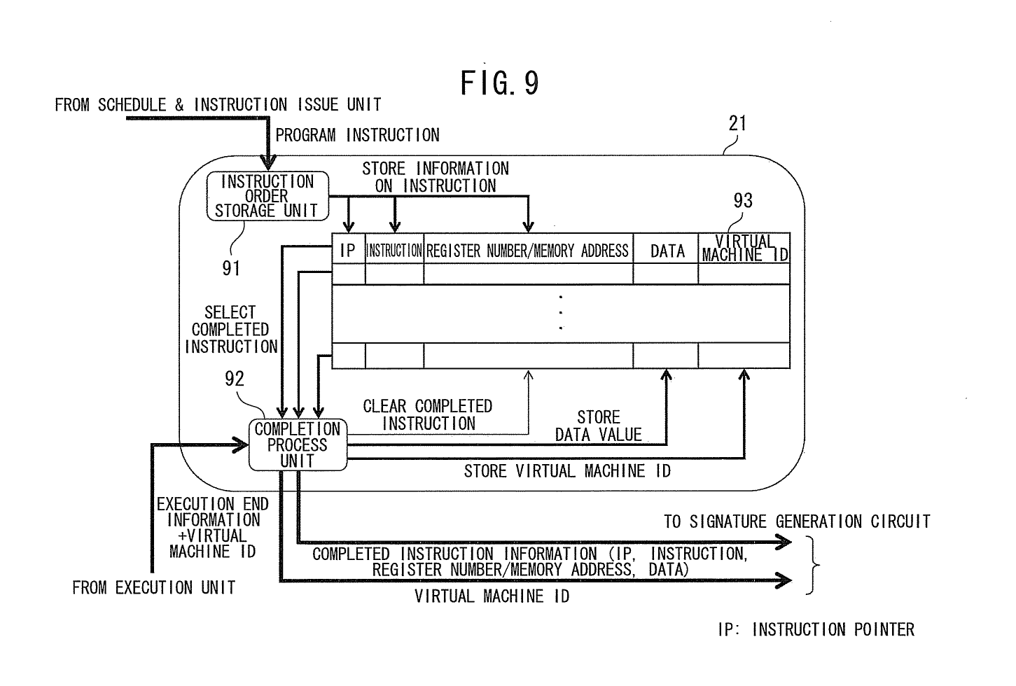

FIG. 9 shows a structure of the retire unit 21 according to an embodiment.

In the same manner as in an embodiment, the retire unit 21 includes an instruction order storage unit 91, a completion process unit 92, and a reorder buffer 93.

The difference between this embodiment and the above-identified embodiment is that, information on an instruction execution has ended, and the ID of a virtual machine which has executed the instruction are sent from the execution unit 24 to the completion process unit 92. In addition, the reorder buffer 93 has a region where a virtual machine ID is stored so that the virtual machine ID is also stored therein.

The completed instruction information is read such that it is selected out of the reorder buffer 93 based on the information on the instruction whose execution has ended sent from the execution unit 24, and is outputted. At that time, the virtual machine ID is outputted to the signature generation circuit 81. Then, by using the virtual machine ID outputted to the signature generation circuit 81 as a selection key, one of the plurality of signature registers 0 to n (83-0 to 83-n) which is to be used is selected.

In the case of execution in a plurality of processes, a process ID is sent, instead of the virtual machine ID, from the execution unit 24, but a description will be given hereinbelow to the case of execution in the virtual machine by way of example.

A case where execution is performed by switching a plurality of virtual machines using a time sharing is considered. In this case, instruction execution in a given virtual machine may be interrupted by an interruption or the like, and switched to the instruction execution in another virtual machine. It is assumed herein that a virtual machine A and a virtual machine B are operating in parallel using time sharing. It is assumed that the signature corresponding to the instruction execution in the virtual machine A is stored in the signature register 0 (83-0), and the signature corresponding to the instruction execution in the virtual machine B is stored in the signature register 1 (83-1). Further, it is assumed that the virtual machine ID is stored in a virtual machine ID register in a register file 23. The instruction executed by the execution unit 24 is sent together with the virtual machine ID register to the retire unit 21, and stored in a reorder buffer 93 in the retire unit 21. The virtual machine ID represents either the virtual machine A or the virtual machine B in which execution is performed. It is assumed that the ID corresponding to the virtual machine A is 0, and the ID corresponding to the virtual machine B is 1.

When the instruction execution in the virtual machine A is started, the instruction executed by the execution unit 24 is sent together with the value 0 of the virtual machine ID register to the retire unit 21 and stored in the reorder buffer 93 to await the completion of the instruction. When the instruction is completed in the retire unit 21, the retire unit 21 simultaneously sends the value 0 as the ID corresponding to the virtual machine A and the completed instruction information to the signature generation circuit 81. Since the selection circuit 84 associated with the signature register selects among the signature registers based on the value 0, the signature register 0 (83-0) is selected. As a result, a new signature is generated based on the value of the signature register stored in the selected signature register 0 (83-0) and the completed instruction information sent from the retire unit 21, and stored in the signature register 0 (83-0).

When the virtual machine in which execution is performed is switched from the virtual machine A to the virtual machine B with the interruption, the value of the virtual machine ID register in the register file is also updated from 0 as the ID representing the virtual machine A to 1 as the ID representing the virtual machine B. In this state, when the instruction is executed by the execution unit 24, information on the executed instruction is sent together with 1 as the ID representing the virtual machine B to the retire unit 21. When the instruction is completed in the retire unit 21, the completed instruction information is sent together with 1 as the ID representing the virtual machine B to the signature generation circuit 81. As a result, the signature register 1 (83-1) is selected in the selection circuit 84 associated with the signature register in the same manner as before. As a result, a new signature is generated based on the content of the signature register 1 (83-1) and the completed instruction information, and stored in the signature register 1 (83-1).

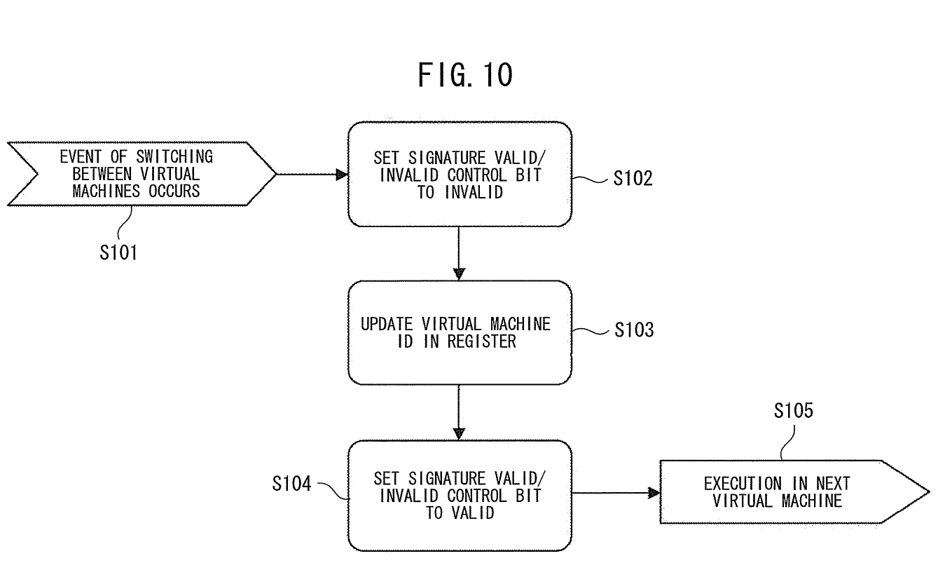

Thus, by preparing the plurality of signature registers and the selection circuit, even when the virtual machine is switched, it becomes possible to save the value of the signature register in the memory. In addition, it is unnecessary to return the value of the signature register from the memory, and the signatures for the respective virtual machines can be easily recorded individually and independently. This is obvious also from FIG. 10 showing the flow of an embodiment corresponding to the flow (FIG. 7) of an embodiment.

In FIG. 10, the event of switching between the virtual machines occurs at operation (S101). The signature valid/invalid control bit, for example using the signature valid/invalid control bit 82 is set to “Invalid” at operation (S102). Then, the value of the virtual machine ID register in the register file is updated to the ID of the virtual machine in which execution is performed at operation (S103).

The signature valid/invalid control bit, for example the signature valid/invalid control bit 82 is set to “Valid” at operation (S104). Then, a process in the next virtual machine is executed at operation S105.

In FIG. 7 showing the flow of an embodiment, saving the content of the signature register, and returning the value to the signature register are processed every time the execution in the virtual machine is switched. However, in FIG. 10 showing the flow of an embodiment, it is unnecessary to store and clear the value of the signature register on each switching of the virtual machine, and signature generation can be easily performed in an environment in which a plurality of virtual machines exist in mixed relation.

Then, with the signatures generated as described above, and stored in the plurality of signature registers, verification in the multiple system is performed in the same manner as shown in FIG. 4 in an embodiment. Unlike in the above-identified embodiment, the process is individually executed in the plurality of virtual machines in an embodiment. The instructions executed in each of the virtual machines are individually counted, an interruption is generated at the time when the number of instructions reaches a predetermined number, and the values of the signature registers in the system are collected in one of the plurality of processors so that a comparison process is performed. At that time, the physical timings of the individual processors may be different from each other. In that case, the virtual machine in which execution is ended early awaits the late end of execution in another virtual machine. Otherwise, the next process is performed speculatively without awaiting.

Thus, the detailed description has been given to the embodiments. To implement the embodiment(s), it is sufficient to merely add a signature generation circuit, a signature valid/invalid control bit, and a signature register to a conventional processor. Each of the embodiments can be implemented with a simple circuit at a relatively low cost. In addition, hardware cost can also be reduced.

According to the present embodiments, it is possible to precisely generate a signature even in a processor which performs out-of-order execution. In addition, the present signature generation method can be implemented with ease at a relatively low cost.

Moreover, it becomes possible to verify reliability in a multiple system constituted by a processor which performs out-of-order execution, and provide a high-performance and high-reliability multiple system.

It will be easily appreciated that the present invention is not limited to the embodiments described above, and various changes and modifications may be made in the invention without departing from the gist thereof. As stated at the beginning, the present embodiments have been described by showing a system structure in which a plurality of processors operate in parallel as the multiple system as shown in FIG. 1. However, the multiple system may also have a structure in which the same process is repeated n times in one processor, and a comparison is made among generated signatures. In that case, in FIG. 4, the process from operations S41 to S45 is repeated n times to generate the signatures corresponding to the respective processes, which are stored in another register or the like and are collected thereafter at operation S46, and then a comparison/verification process is performed. In an embodiment, the completed instruction information is the same as in the embodiment (A). However, in the embodiment also, the completed instruction information may have a structure which uses only information to be written to the memory, in the same manner as in the embodiment (B). Thus, the present invention is not limited to the embodiments described above. The present invention can be appropriately modified within the range not departing from the gist thereof, and practiced. Further, some or part of the operations described herein may be implemented via separate components or program applications.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A processor which performs an instruction execution regardless of a program order, the processor comprising:
an execution unit for executing an instruction, and transmitting end information of the instruction whose execution has ended;
a retire unit for receiving the end information transmitted by the execution unit, rearranging a result of the instruction whose execution has ended in the program order to determine the instruction execution, and transmitting completed instruction information which reports that the instruction execution has been determined; and
a signature generation unit for receiving the completed instruction information from the retire unit, and generating a signature using the completed instruction information.

2. The processor according to claim 1, comprising:
a signature register for storing the signature generated by the signature generation unit, and
wherein a value stored in the signature register is read and subjected to a comparative verification using a task switch generated by the execution unit every time a given number of instructions are executed.

3. The processor according to claim 1, wherein the signature generation unit generates the signature using information included in the completed instruction information which causes an influence outside of the processor.

4. The processor according to claim 3, wherein the information which causes the influence outside the processor is obtained by extracting only information to be written to a memory from the completed instruction information.

5. The processor according to claim 1, comprising:
a plurality of signature registers for storing the signature generated by the signature generation unit; and
a selection unit for selecting one of the signature registers in which the generated signature is to be stored based on a state at a time of the instruction execution.

6. The processor according to claim 5, wherein the state of the instruction execution is a virtual machine ID or a process ID which shows a virtual machine in which the instruction is executed or a process in which the instruction is executed.

7. A multiple system constructed by connecting a plurality of processors which perform an instruction execution regardless of a program order, the multiple system comprising:
an execution unit for executing an instruction, and transmitting end information of the instruction whose execution has ended;
a retire unit for receiving the end information transmitted by the execution unit, rearranging a result of the instruction whose execution has ended in the program order to determine the instruction execution, and transmitting completed instruction information which reports that the instruction execution has been determined;
a signature generation unit for receiving the completed instruction information from the retire unit, and generating a signature using the completed instruction information, and
a verification unit for collecting a plurality of the signatures which are generated in the individual processors correspondingly to a given amount of processing by a specified one of the processors, comparing the collected signatures with each other, and verifying a match among the collected signatures.

8. A signature generation method in a processor which performs an instruction execution regardless of a program order, the generation method comprising:
generating a signature using completed instruction information showing that an instruction is executed, rearranging a result of the instruction whose execution has ended in the program order, and determining the instruction execution.

9. The generation method according to claim 8, wherein the signature is generated using only information included in the completed instruction information which causes an influence outside of the processor.

10. The generation method according to claim 8, wherein the processor comprises a plurality of signature registers for storing the generated signature, selects the register in which the generated signature is to be stored from among the plurality of signature registers in accordance with a state at a time of the instruction execution, and stores the generated signature therein.
